(19) United States
(12) Patent Application Publication
(10) Pub. No.: US 2017/0090900 A1
(43) Pub. Date: Mar. 30, 2017

(54) DETERMINING PATCH APPLICABILITY ON RUNNING SYSTEMS

(71) Applicant: INTERNATIONAL BUSINESS MACHINES CORORATION, Armonk, NY (US)

(72) Inventors: Jack S. Baines, Winchester (GB); Kirstine F. L. Clapperton, Southampton (GB); David J. Crighton, Southampton (GB); Paul J. Lacy, Hampshire (GB); Rosanna M. Lickorish, Middlesex (GB)

(21) Appl. No.: 14/871,478

(22) Filed: Sep. 30, 2015

(51) Int. Cl. G06F 9/445

(52) U.S. Cl. CPC G06F 8/65

(57) ABSTRACT

A patch applicability capability is provided that indicates whether a particular patch is to be installed on a system. The capability includes detecting whether the patch applies to code actually being executed on the system in which the patch is to be installed. If the patch applies to code actually being executed, then the patch may be installed. Otherwise, the patch may not be installed.

### BACKGROUND

One or more aspects relate, in general, to processing within a computing environment, and in particular, to applying patches to correct errors within the computing environment.

Many customers, including, but not limited to, those running mission critical systems, wish to limit the number of changes applied to their systems in order to reduce the risk of impacting workload or reduce the cost of re-testing impacted workloads.

Currently, when maintenance fixes are available for a product, a customer uses a fix-list to evaluate if the risk of hitting known issues fixed by a patch (code used to fix a problem or change other code) outweighs the risk of applying the patch.

### SUMMARY

Shortcomings of the prior art are overcome and additional advantages are provided through the provision of a computer program product for determining applicability of a patch. The computer program product comprises a storage medium readable by a processing circuit and storing instructions for execution by the processing circuit for performing a method. The method includes obtaining, by a processor of a system, data regarding code currently running on the system; checking, based on the data obtained, whether a patch to be installed on the system applies to code actually being executed on the system; and determining, based on the checking, whether the patch is to be installed on the processor, wherein the determining indicates the patch is to be installed based on the checking indicating the patch applies to the code actually being executed on the system.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and/or use one or more aspects of the present invention;

FIGS. 2A-2B depict further details of the processing unit of FIG. 1, in accordance with an aspect of the present invention;

FIG. 3 depicts one embodiment of logic to determine whether a patch is to be installed, in accordance with an aspect of the present invention;

FIGS. 4A-4B visually depict one example of determining whether a code patch is to be installed, in accordance with an aspect of the present invention;

FIG. 5 depicts a further embodiment of logic to determine whether a patch is to be installed, in accordance with an aspect of the present invention;

FIG. 6 depicts one embodiment of a cloud computing environment; and

FIG. 7 depicts one example of abstraction model layers.

### DETAILED DESCRIPTION

In accordance with an aspect of the present invention, a patch applicability capability is provided that indicates whether a particular patch is to be installed on a system (e.g., on a processor of the system). The capability includes detecting whether the patch applies to code actually being executed on the system in which the patch is to be installed.

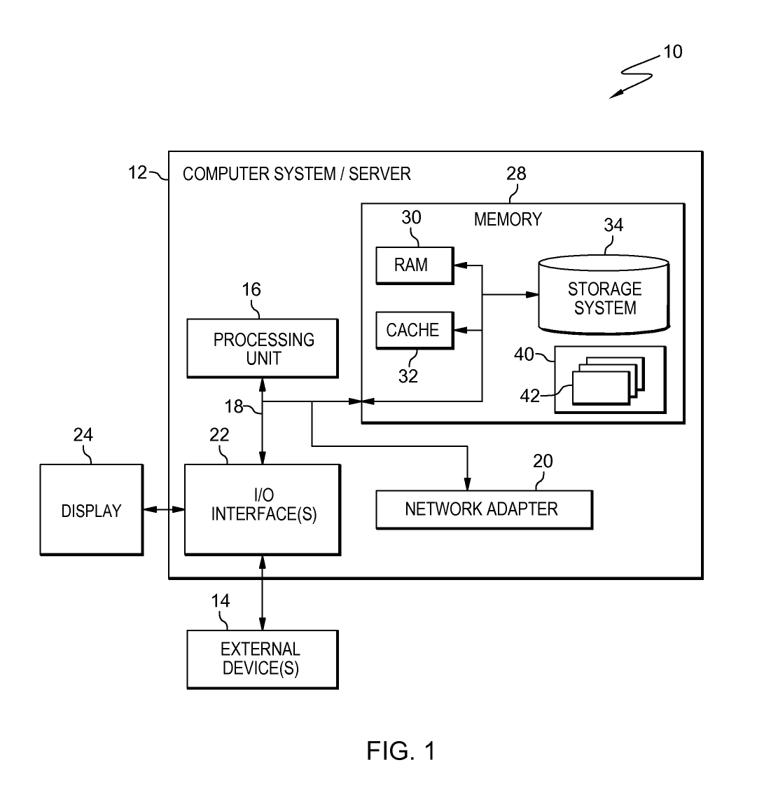

One example of a computing environment to incorporate and/or use one or more aspects of the present invention is described with reference to FIG. 1. In one example, the computing environment includes a computing node 10, which includes a computer system/server 12 that is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks, such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

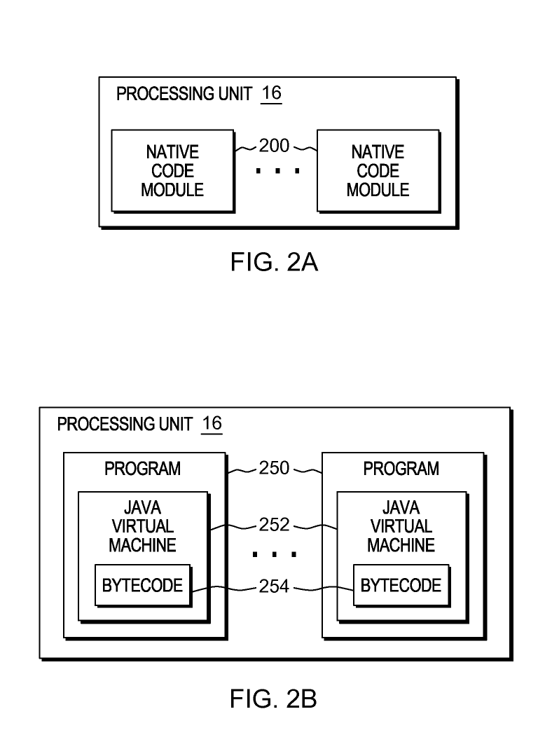

Processing unit 16 may, as shown in FIG. 2A, execute native code modules 200. However, in another embodiment, as shown in FIG. 2B, processing unit 16 may execute one or more programs 250 that include one or more Java virtual machines 252. A Java virtual machine may execute bytecode 254. Bytecode is the compiled format for Java programs. Once a java program has been converted to bytecode, it can be executed by a Java virtual machine.

In accordance with aspects of the present invention, a capability is provided to determine whether a patch to fix or change code running on a system is to be applied to the system, regardless of whether the system executes native code modules or bytecode. This capability, referred to herein as a patch applicability capability, obtains data relating to whether a patch is to be installed on the system. Data regarding code currently running on the system is obtained, and the obtained data is used to determine whether the patch is to be installed. Based on the obtained data, a determination is made as to whether the patch applies to code actually being executed on the system. If the patch applies to code actually being executed on the system, the patch may be applied to the system. Otherwise, it may be decided not to apply the patch.

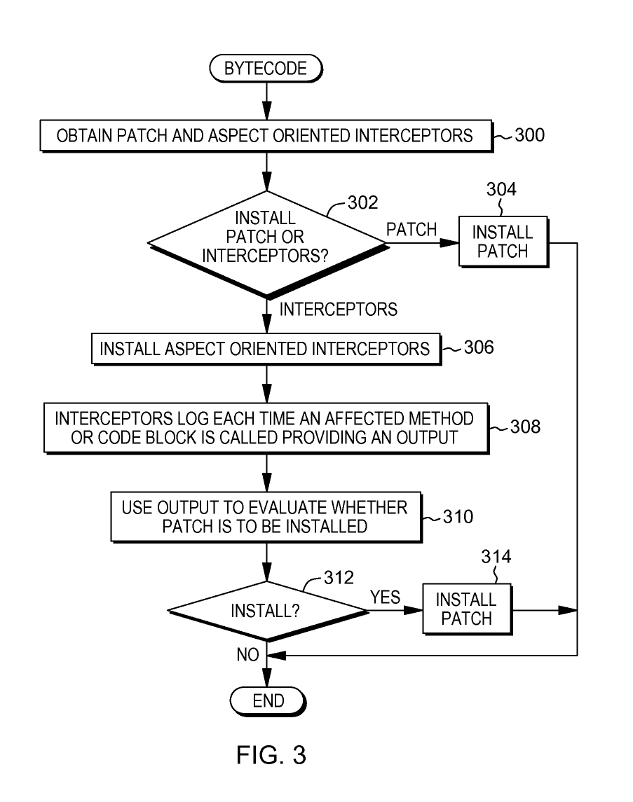

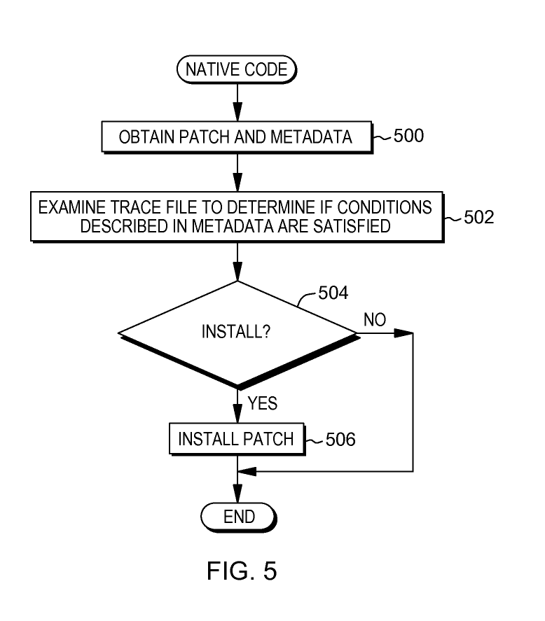

In one embodiment, the data may be obtained via, for instance, an aspect oriented interceptor, as described below. One embodiment of logic to use aspect oriented interceptors to determine the applicability of a patch to a particular system is described with reference to FIG. 3. Further, one embodiment of logic to use metadata to determine the applicability of a patch is described with reference to FIG. 5.

Initially, referring to FIG. 3, one embodiment of logic associated with determining whether a patch is applicable to a currently executing system is provided. In this particular example, the logic is for bytecode compiled languages in which aspect oriented interceptors are generated. The logic is performed by a processor of the system.

Referring to FIG. 3, a patch and one or more aspect oriented interceptors are obtained by (e.g., provided to) a system, STEP 300. For instance, for bytecode compiled languages, when a code change is made, an aspect oriented interceptor is generated for one or more (e.g., all) methods changed by the patch. As examples, one interceptor may be generated for all methods, one interceptor may be generated for each method, or some combination thereof. The generation of the aspect oriented interceptors could either be performed automatically as part of a build step, or manually written if the criteria for a fix is very tightly isolated. The one or more aspect oriented interceptors are obtained by the system and used to obtain data relating to whether a patch is to be installed on the system.

An aspect oriented interceptor is a small snippet of code that can be applied at one or more points in a program. One example of such an interceptor is:

```
aspect {
  bool patchApplicability = false;
  after( ) :call(void MyExampleClass.runTask2( )){
      //only report once
      if(!patchApplicability){
          System.out.println(″Patch is applicable″);
      }
          patchApplicability = true;
  }
}
```

A determination is then made as to whether the patch or the aspect oriented interceptors are to be installed in the system, INQUIRY 302. If the patch is to be installed, then the patch is installed as in previous techniques, STEP 304, and processing is complete. However, if it is determined that the one or more aspect oriented interceptors are to be installed, INQUIRY 302, then those interceptors are installed, STEP 306. The interceptors log each time an affected method or code block is called providing an output, STEP 308. The output is used to evaluate whether the patch is to be installed, STEP 310. For instance, if the output indicates an affected method or code block was called, then the patch may be installed. However, if the output indicates no executed code was affected, then the patch may not be installed. In a further embodiment, the output may be evaluated to determine how often the affected code may be hit, and the outcome of this evaluation is used to determine whether the patch is to be installed. If the patch is to be installed, INQUIRY 312, then it is installed as in known techniques, STEP 314. Otherwise, processing is complete.

Consider for bytecode based code, the following method that is part of a larger program:

```
class MyExampleClass{
  public static void main(String[ ] args){
      if(args[0] = ″runTask1″){
          runTask1( );
      }
      else{
          runTask2( );
      }
  }
  public static void runTask1( ){
      //do some stuff
  }
  public static void runTask2( ){
      System.out.println(″brokenFunctionality!!!!!!!!″);
  }
}
```

In this example, the Java program represents a more complex program, and the method runTask2 represents a method which has a defect for which a fix will be issued. As can be seen for some workloads, the affected method will never be run and a goal is for the customer to be able to automatically determine if the patch that is generated is applicable to their system.

In this case, the patch will be replacing runTask2( ) with the following method:

public static void runTask2( ){
System.out.println(″Fixed functionality!!!″);
}

Using aspect orientated programming, it is possible to determine whether runTask2 has ever been executed by introducing the following aspect:

```
aspect {
  bool patchApplicability = false;
  after( ) :call(void MyExampleClass.runTask2( )){
      //only report once
      if(!patchApplicability){
          System.out.println(″Patch is applicable″);
      }
          patchApplicability = true;
  }
}
```

In this instance, the variable patchApplicability can be used by other parts of the system to programmatically determine patch applicability and the output to System.Out informs the user if the patch is applicable. Note that these aspects can be installed into a product without modifying product behavior provided that the aspectJ libraries are already in the bootstrap call loader. Load time weaving allows an aspect to be installed providing the underlying product is capable of reloading it's classes. For the IBM Integration Bus, this may happen as part of a deploy, for example.

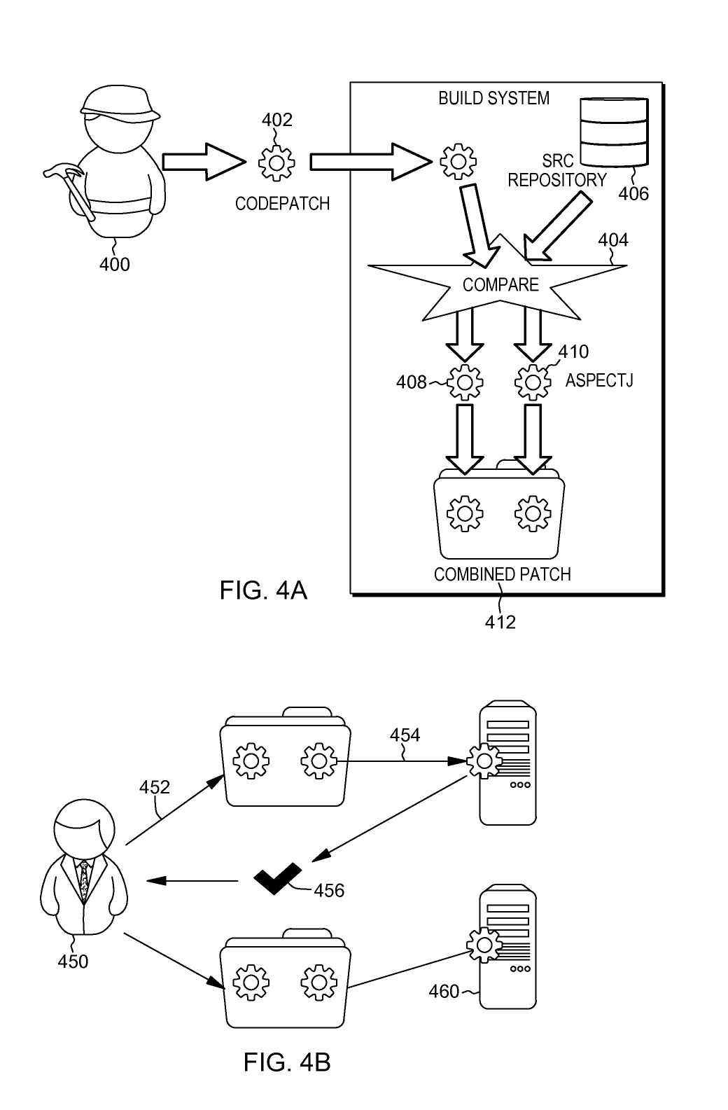

The above process for determining whether a patch is to be installed is visually depicted in FIGS. 4A-4B. In FIG. 4A, a service engineer 400 identifies an error in some code and produces a patch 402. As part of an automated build system, the patch is compared 404 against the source code repository 406 to generate a compiled version of the patch 408, as well as a set of aspect interceptors (ASPECTJ) 410 generated for each area of code change. An area of code may be a method, block or statement, as examples. The aspect interceptors are packaged along with the binary fix into a combined package (also referred to herein as a combined patch) 412 and made available for download.

At a later time, a customer 450 obtains the combined patch 452 and wishes to determine if the patch is applicable to the customer's system. Via an automated install script, the interceptors are installed 454 and the product is instructed to reload its class definitions (e.g., by initiating an IBM Integration Bus deploy or stop/start flow). If an aspect interceptor is hit, then positive feedback 456 is returned to the customer and the customer can opt to install the patch onto their server 460 so they are not exposed to the error. If negative feedback is returned; that is, the affected code has not been called, then the customer can opt to avoid the risk and test costs associated with applying the patch, safe in the knowledge that they are not exposed to the error.

In a further embodiment, the aspect oriented interceptors may be turned on (as a one off activity) to collect an execution profile for their workload. The collected metadata could then be compared to the methods changed by individual patches to indicate applicability. The advantage of this technique is that the collection of data on a running workload is only performed once as a one off cost.

In yet a further embodiment, metadata is collected about the methods which are changed by a patch and used to determine whether the patch is to be installed. As examples, this logic is applicable for any language fix, including languages compiled to bytecode, as well as native code modules where the ability to dynamically intercept running code is limited.

Referring to FIG. 5, during patch generation, which is either an automated build process or a manual step, metadata is collected about the methods which are changed by the patch, or other distinguishing features that indicate that a customer might be vulnerable to a known issue, e.g., a particular series of methods which are to be called in sequence. This metadata is distributed with the patch, along with an analysis program, which is capable of examining a trace file produced by the program, STEP 500. The trace file is examined, by the processor on which the patch is to be installed, to determine if conditions described in the metadata are satisfied, STEP 502. Based on this information, a determination is made as to whether the customer is vulnerable to the problem fixed by the patch, and whether the patch should be installed, INQUIRY 504. For instance, the metadata is used to determine if code actually running within the system is hit by the problem being fixed by the patch. If the code is hit, then the patch may be installed. Otherwise, the customer may elect not to install the patch. If the patch is not to be installed, then processing is complete. However, if the patch is to be installed, then it is installed as in known techniques, STEP 506.

One example of using metadata is described below. In this embodiment, the target product is expected to have trace capability which can be enabled and disabled in order to diagnose problems. An example of a product with this kind of trace system is Integration Bus offered by International Business Machines Corporation. In this system, when a patch is developed by an engineer, such as an L3 engineer, the build system compares this to the source code and determines what the nearest trace points are that would be expected if the affected code was called. For example, in the sample code below, the trace point log entry (“myMethod”) shows that the affected method is called:

```
void MyClass::myMethod( ){
    logEntry(″myMethod″);
    if(someCondition){
        logNamedTrace(″I did something″);
        /**
        Affected codeblock
        **/
    }
    logExit( );
}
```

This might write to the trace log:
23/09/2015 02:34.23452345 MyClass::MyMethod {
23/09/2015 02:34.23452345 MyClass::MyMethod—I did something
23/09/2015 02:34.23452345 MyClass::MyMethod}

So, for example, if the patch made a change inside the if(someCondition) block, then it is known from static analysis that this will affect any system that records the middle line in it's output log.

Some examples of a real trace from a selected product in which some methods could reach dozens of levels of nesting and be split over thousands of lines/calls to other methods, include:
2015-04-22 17:11:08.703284 7288 {ImbDataFlowDirector::prepare 21b250ba-4c01-0000-0080-dbee8f23a4db ExecutionGroup, TEST
2015-04-22 17:11:08.703290 7288 ImbDataFlowDirector::prepare 21b250ba-4c01-0000-0080-dbee8f23a4db ExecutionGroup ‘About to process manager list’, TEST
2015-04-22 17:11:08.703297 7288 ImbDataFlowDirector::prepare 21b250ba-4c01-0000-0080-dbee8f23a4db ExecutionGroup ‘End of process manager list’, TEST
2015-04-22 17:11:08.703303 7288 {ImbPersistentResource::prepare 21b250ba-4c01-0000-0080-dbee8f23a4db ExecutionGroup, TEST
2015-04-22 17:11:08.703309 7288} ImbPersistentResource::prepare 21b250ba-4c01-0000-0080-dbee8f23a4db ExecutionGroup, TEST
2015-04-22 17:11:08.703316 7288} ImbDataFlowDirector::prepare 21b250ba-4c01-0000-0080-dbee8f23a4db ExecutionGroup, TEST

Here, ImbDataFlowDirector::prepare calls ImbPersistentResource::prepare, and the curly braces represent entry and exit to the methods. The 2 lines:
2015-04-22 17:11:08.703290 7288 ImbDataFlowDirector::prepare 21b250ba-4c01-0000-0080-dbee8f23a4db ExecutionGroup ‘About to process manager list’, TEST
2015-04-22 17:11:08.703297 7288 ImbDataFlowDirector::prepare 21b250ba-4c01-0000-0080-dbee8f23a4db ExecutionGroup ‘End of process manager list’, TEST
   are inline trace statements similar to the middle line in the simplified example.

The trace point logNamedTrace(“I did something”) can be used as evidence that the code represented by the commented out block has been executed. The build system performs static analysis to determine the nearest tracepoint that would be present if the affected code block was called. This is recorded with the fix as metadata given in a separate file packaged with the fix.

When a customer receives the fix, the customer has the option to, instead of applying the patch directly, enabling trace and running sample workload through the system. A simple program provided with the trace data would then examine the trace for any of the tracepoints stored in the metadata in order to report applicability of the fix.

Regardless of the approach, patch applicability is determined based on the exact code paths that are executed on the customer's system for their particular workload, rather than a capability or component based analysis which may indicate a broader applicability. Therefore, the patch applicability approach can be targeted more specifically to the customer environment. The customer is therefore not exposed to an un-required level of risk associated with accepting fixes that are not applicable to their running scenario.

One or more aspects of the invention are applicable to hybrid native/java programs, such as IBM Integration Bus, where patches may include a mix of both native and java code changes. In this circumstance, the two different techniques would be orchestrated by a simple utility provided with the combined patch files so the users obtain a simple positive or negative indicator of patch applicability.

As described herein, in one embodiment, a capability is provided to identify if a first software fix/patch is applicable to:

1. A bytecode compiled language (e.g., Java) by:
1 a. Creating a second software fix/patch utilizing aspects to insert bytecode at those points modified by the first software fix/patch.
1b. The second software fix/patch being instructed to log a message if an affected method or code block is executed. The message may be logged either every time an affected code block is executed or only on first execution.

2. Any other language (e.g., C++) by:
2a. Creating a list of trace statements through static code analysis identifying those closest to all changes within a first software fix/patch.
2b. Enabling trace on the target software and comparing the trace output to the list of trace statements associated with the first software fix/patch.

Indicating applicability of the first software fix/patch if the second software fix/patch or trace comparison logs a message showing that the methods/code blocks affected by the first software fix/patch are executed.

In accordance with one or more aspects, customers can pre-emptively determine if they are vulnerable to known defects without having to experience a problem. A customer can pre-emptively determine if a patch is applicable to the customer's system without having to experience the problem. The customer can determine, e.g., automatically via computer processing, whether a patch is applicable based on whether the system would actually execute the code paths affected by the patch.

One or more aspects may relate to cloud computing.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

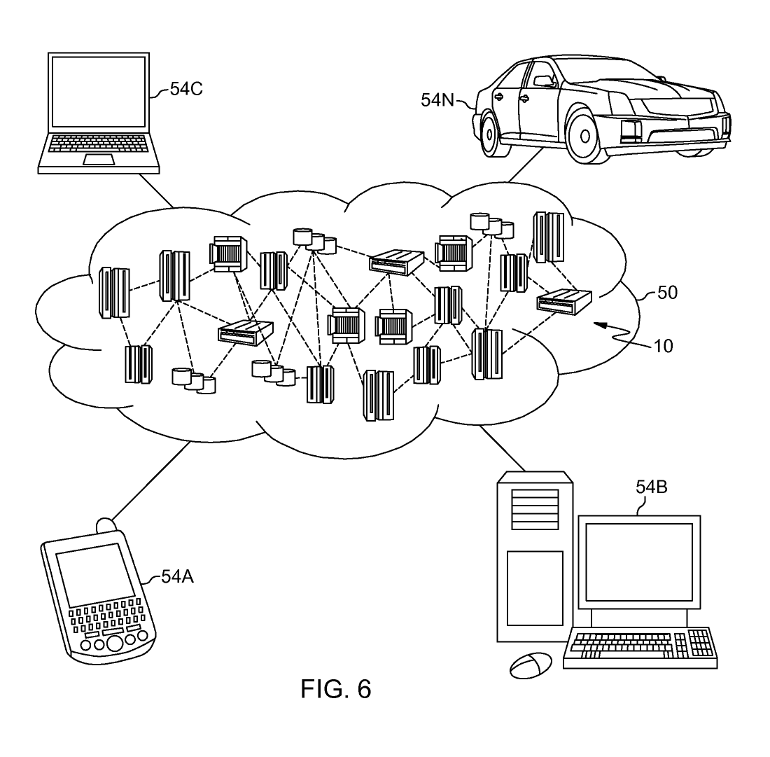

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

A schematic of one example of a cloud computing node 10 is shown in FIG. 1. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

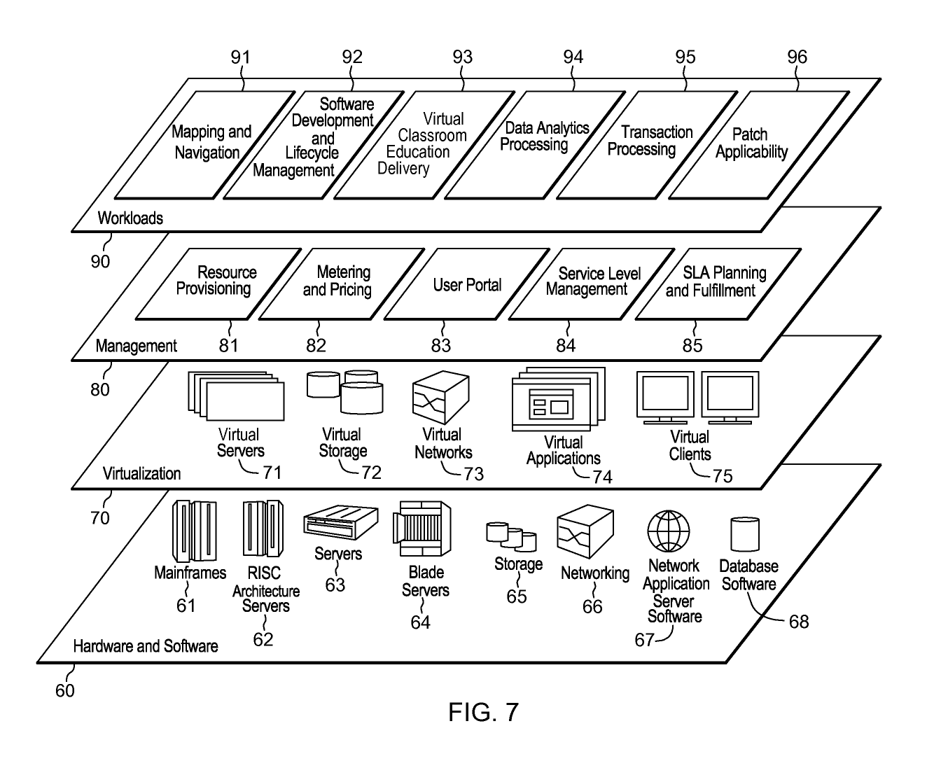

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and patch applicability processing 96.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, computing environments of other architectures can be used to incorporate and use one or more embodiments. Further, other types of computing environments, such as emulated environments, may include one or more aspects of the present invention. The emulated environment may include emulator code that enables the processing environment configured in one architecture to emulate another architecture. Many variations are possible.

Further, other types of computing environments can benefit and be used. As an example, a data processing system suitable for storing and/or executing program code is usable that includes at least two processors coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for determining applicability of a patch, the computer program product comprising:
a storage medium readable by a processing circuit and storing instructions for execution by the processing circuit for performing a method, the method comprising:
obtaining, by a processor of a system, data regarding code currently running on the system;
checking, based on the data obtained, whether a patch to be installed on the system applies to code actually being executed on the system; and
determining, based on the checking, whether the patch is to be installed on the processor, wherein the determining indicates the patch is to be installed based on the checking indicating the patch applies to the code actually being executed on the system.

2. The computer program product of claim 1, wherein the obtaining comprises using one or more aspect oriented interceptors to obtain the data.

3. The computer program product of claim 2, wherein the using comprises logging, by the one or more aspect oriented interceptors, one or more times an affected area of code is called, providing an output.

4. The computer program product of claim 3, wherein the determining comprises using the output to evaluate whether the patch is to be installed.

5. The computer program product of claim 1, wherein the data is a trace file, and the checking comprises examining the trace file to determine whether one or more conditions described in metadata provided to the system is indicated in the trace file.

6. The computer program product of claim 5, wherein the metadata comprises one or more trace points determined by a trace and related to the patch.

7. The computer program product of claim 1, wherein the determining indicates the patch is not to be installed based on the checking indicating the patch does not apply to code actually being executed on the system.

8. The computer program product of claim 1, wherein the method further comprises obtaining, by the processor, the patch and one or more aspect oriented interceptors to be used to obtain the data.

9. The computer program product of claim 8, wherein the method further comprises:
determining whether the one or more aspect oriented interceptors is to be installed;
installing the one or more aspect oriented interceptors, based on the determining indicating the one or more aspect oriented interceptors is to be installed; and
wherein the obtaining the data comprises using the one or more aspect oriented interceptors that are installed to obtain the data.

10. The computer program product of claim 1, wherein the method further comprises obtaining the patch and metadata to be used to examine the data to determine whether the patch is to be installed.

11. A computer system for determining applicability of a patch, the computer system comprising:
a memory; and
a processing circuit in communication with the memory, wherein the computer system is configured to perform a method, the method comprising:
obtaining data regarding code currently running on a system;
checking, based on the data obtained, whether a patch to be installed on the system applies to code actually being executed on the system; and
determining, based on the checking, whether the patch is to be installed on the processor, wherein the determining indicates the patch is to be installed based on the checking indicating the patch applies to the code actually being executed on the system.

12. The computer system of claim 11, wherein the obtaining comprises using one or more aspect oriented interceptors to obtain the data.

13. The computer system of claim 12, wherein the using comprises logging, by the one or more aspect oriented interceptors, one or more times an affected area of code is called, providing an output.

14. The computer system of claim 11, wherein the data is a trace file, and the checking comprises examining the trace file to determine whether one or more conditions described in metadata provided to the system is indicated in the trace file.

15. The computer system of claim 14, wherein the metadata comprises one or more trace points determined by a trace and related to the patch.

16. A computer-implemented method of determining applicability of a patch, the computer-implemented method comprising:
obtaining, by a processor of a system, data regarding code currently running on the system;
checking, based on the data obtained, whether a patch to be installed on the system applies to code actually being executed on the system; and
determining, based on the checking, whether the patch is to be installed on the processor, wherein the determining indicates the patch is to be installed based on the checking indicating the patch applies to the code actually being executed on the system.

17. The computer-implemented method of claim 16, wherein the obtaining comprises using one or more aspect oriented interceptors to obtain the data.

18. The computer-implemented method of claim 17, wherein the using comprises logging, by the one or more aspect oriented interceptors, one or more times an affected area of code is called, providing an output.

19. The computer-implemented method of claim 16, wherein the data is a trace file, and the checking comprises examining the trace file to determine whether one or more conditions described in metadata provided to the system is indicated in the trace file.

20. The computer-implemented method of claim 19, wherein the metadata comprises one or more trace points determined by a trace and related to the patch.
